(19) United States
(12) Patent Application Publication
(10) Pub. No.: US 2015/0148942 A1
(43) Pub. Date: May 28, 2015

(54) Control Board and Dispenser Security Monitoring System

(71) Applicants: C. Owen DeWitt, Duncan Falls, OH (US); Rick Rose, Duncan Falls, OH (US)

(72) Inventors: C. Owen DeWitt, Duncan Falls, OH (US); Rick Rose, Duncan Falls, OH (US)

(21) Appl. No.: 14/088,426

(22) Filed: Nov. 24, 2013

(51) Int. Cl. B67D 7/32; G05B 15/02; H02H 1/00; B67D 7/04

(52) U.S. Cl. CPC B67D 7/3218; B67D 7/04; G05B 15/02; H02H 1/0061
USPC 700/231

(57) ABSTRACT

The invention is a dispenser security system which has a control board that controls one or more fuel dispensing components to prevent the flow of fuel from the dispenser if the security system detects that dispenser is being tampered with. If the control board detects tampering based on a select criteria it will turn off the power using a breaker.

### BACKGROUND OF INVENTION

1. Field of the Invention

The present invention is directed to a providing Dispenser Security Monitoring System more particular one that can monitor at a distance and send warning messages from a control board.

2. Background

Fuel theft from retail dispensers is a significant source of economic loss for fuel retailers. Current fueling facilities rely on remote monitoring of the fueling process by fuel retailer personnel and “self service” dispensing of the fuel into the vehicle, making the facilities vulnerable to theft of fuel. Often, by the time the monitoring personnel becomes aware of the theft, the thief has already left the facility and the loss has already occurred. When diesel fuel is stolen by a driver of an over-the-highway tractor, a large amount of fuel can be lost in a single theft.

Fuel is stolen from retail dispensers using many techniques. For example, doors or panels on the fuel dispenser can be opened or removed to provide access to internal metering components of the dispenser such as pulsars. The metering component can be disabled so that fuel may be pumped from the dispenser without triggering any indication of fuel flow. In other cases, the dispenser is placed in a programming mode that is normally used to change operating characteristics of the fuel dispenser. When the dispenser is in programming or stand alone mode, fuel can be pumped from the dispenser without triggering any indication of fuel flow.

There is still room for improvement in the art.

### SUMMARY OF THE INVENTION

The invention is a dispenser security system controls one or more fuel dispensing components to prevent the flow of fuel from the dispenser if the security system detects that dispenser is being tampered with. The dispenser security system includes one or more sensors that detect and send signals indicative of tampering, a dispenser security controller that receives the tampering signals, and one or more dispenser disablement mechanisms that prevent flow of fuel from the dispenser. The dispenser security controller controls the dispenser disablement mechanisms based on inputs from the sensors including a light sensor.

The system accepts a signal from any device or security component to the board. The board programming then instructs the system to take the appropriate action for outputs.

Outputs can vary from sending a signal to the appropriate relay to kill power (stopping fuel loss) to sending alerts to digital keypad/display as well as sending alerts through network connection as email or text. This can be done based on certain criteria as set by a user.

The System is a Real Time” system that prevents real loss. With the “Real Time” system, it will know if someone is tampering with the dispensers, such as installing a skimmer inside, placed it in service mode, or if have an employee assisting in a theft.

Further features and advantages of the invention will become apparent from the following detailed description made with reference to the accompanying drawings.

### BRIEF DESCRIPTION OF THE DRAWINGS

Without restricting the full scope of this invention, the preferred form of this invention is illustrated in the following drawings:

FIG. 1 is a front view of a typical retail fuel dispenser that includes a dispenser security system constructed in accordance with an embodiment of the present invention;

FIG. 2 is a front view of the fuel dispenser of FIG. 1 with an access panel open to show internal components;

FIG. 3 is a perspective view of a dispenser security system constructed in accordance with an embodiment of the present invention;

FIG. 4 is a display of the control board; and

FIG. 5 displays the system sending out and receiving messages.

### BRIEF DESCRIPTION OF THE PREFERRED EMBODIMENTS

There are a number of significant design features and improvements incorporated within the invention.

The invention is a dispenser security system controls one or more fuel dispensing components to prevent the flow of fuel from the dispenser if the security system detects that dispenser is being tampered with. The dispenser security system includes one or more sensors that detect and send signals indicative of tampering, a dispenser security controller that receives the tampering signals, and one or more dispenser disablement mechanisms that prevent flow of fuel from the dispenser. The dispenser security controller controls the dispenser disablement mechanisms based on inputs from the sensors. The sensors may be, for example, can be magnetic reed switches mounted on access panels or near a programming mode switch where when an access panel or programming mode switch is moved out of position, a trigger signal is generated by the dispenser security controller that activates the dispenser disablement mechanism. The dispenser security controller may also activate one or more alert mechanisms. The dispenser disablement mechanism may be, for example, a switch or contactor. The switch or contactor can prevent the flow of power to a control valve that allows the flow of fuel out of the dispenser or the flow of power to a pump that pumps fuel out of the dispenser.

The system accepts a signal from any device or security component to the board. The board programming then instructs the system to take the appropriate action for outputs. Outputs can vary from sending a signal to the appropriate relay to kill power (stopping fuel loss) to sending alerts to digital keypad/display as well as sending alerts through network connection as email or text.

The System uses wireless technology to secure a fuel dispenser in conjunction with an IS barrier. It communicates to a panel receiver that switches a relay to kill power so the theft is prohibited.

The System is a Real Time” system that prevents real loss. With the “Real Time” system, it will know if someone is tampering with the dispensers, such as installing a skimmer inside, placed it in service mode, or if have an employee assisting in a theft.

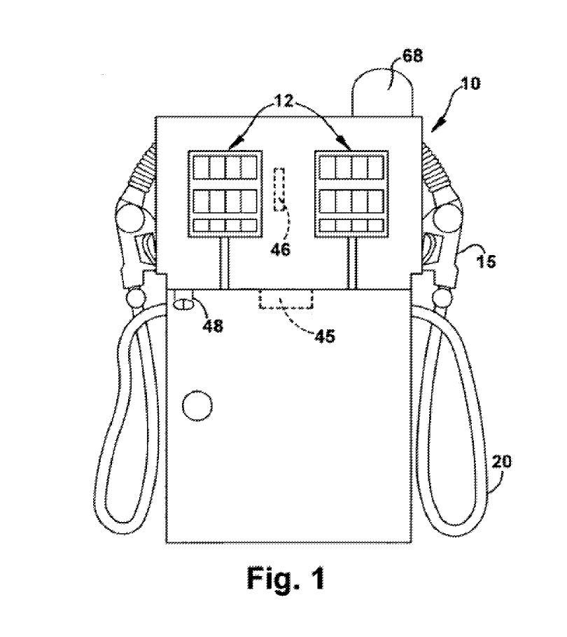

FIG. 1 depicts a typical retail fuel dispenser 10 that is used to pump fuel out of a storage tank 500 through a hose 20 and out of a nozzle 15. The fuel dispenser 10 includes a top enclosure that houses a dispenser control computer and readouts 12 that display information related to the fuel purchase. The dispenser control computer controls operation of the various dispenser components according to stored programming steps. In order to enable programming of the dispenser control computer, a programming enable switch is present on the dispenser. The programming enable switch must be actuated to place the dispenser control computer in a mode in which it can be programmed. When the control computer is in the programming or stand alone mode, fuel may be dispensed from the dispenser without activation of the control computer registering the fact that fuel is being dispensed from the dispenser. In the dispenser shown in FIG. 1, a magnetic programming key switch 48 is in electrical communication with the dispenser control computer and can be actuated to place the computer into the programming enable mode or normal operating mode. Other dispensers have a magnetically actuated programming enable switch (not shown) that is usually located behind a front dispenser panel on which the displays 12 are mounted.

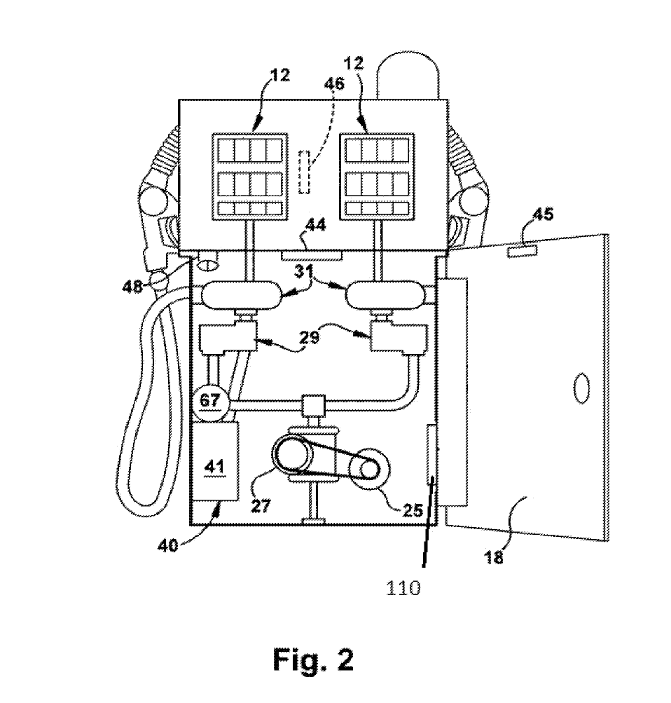

FIG. 2 shows the retail fuel dispenser 10 with an access door 18 open to expose internal components of the fuel dispenser. A pump 27, which in this case is driven by a motor 25, draws fuel from the storage tank. The fuel flows from the pump 27 to one or more control valves 29 that control the rate of flow of fuel to the hose 20. Usually, each dispenser hose 20 has a dedicated control valve. A pulsar 31 electronically monitors a volume of fuel that is flowing from the valve to the hose. The pulsar 31 is in signal communication with the dispenser control computer and provides signals indicative of the volume of fuel flow to the dispenser control computer. The control computer displays an amount of fuel being dispensed on the dispenser displays 12.

In most modern retail fuel establishments, the amount of fuel being dispensed by each dispenser are also communicated to a central control board panel 120 located, for example, at a remote location. The control board 120 is used to enable operation of the pump 10 when dispensing is approved or disable operation of the pump 10 when dispensing has not been approved. In the preferred embodiment, this is done by a breaker 200 cutting power to the pump 10.

For the purposes of this description, the fuel dispenser components shown in FIGS. 1 and 2 are intended as examples of fuel dispenser components. It will be apparent to one of skill in the art that other fuel dispenser configurations and components can be used in various implementations of the dispenser security system. For example, the control valve and pump may be housed within the same housing. The pump may be located within the storage tank. The upper enclosure may have various configurations as well as the display 12.

A dispenser security system 40 is shown installed within the fuel dispenser 10 in FIG. 2. The dispenser security system in the preferred embodiment may include a photo sensor 140, an alarm unit 41, a siren 67, a strobe light 68, and an arming status indicator LED. The alarm unit is electrically connected in series with a low speed power lead to the control valve 29 (FIG. 2). While the connections are not shown in FIGS. 1 and 2, the alarm unit 41 may also be connected to various tamper detection sensors such as a magnetic reed switch 44 mounted in the dispenser that has an associated magnet 45 mounted on a sensor access panel or door 18.

The photosenser 110, reed switches and key switch provide tamper detection inputs to the alarm unit 41 that indicate that the dispenser is being tampered with, such as, for example, a door or panel being opened to access a dispenser metering component or the programming reed or key switch being actuated. When the tamper detection sensors are switches that are configured in a normally open condition as described herein, they can be wired in parallel and tied together to create a single alarm tamper detection input that is turned on when any of the switches closes.

The dispenser security system 40 may includes a photosenser 110 to detect light, an alarm unit 41, a siren 67, a strobe light 68 with the arming status indicator LED 69, and remote controller 120. Because the control valve 29 must be powered for fuel to be dispensed from the dispenser 10, if power 400 is cut fuel cannot be dispensed.

The thieves may attempt to place the dispenser's computer in programming mode so that fuel can be dispensed without console knowledge. In some embodiments, a programming switch sensor that senses operation of the programming enable switch is connected to dispenser security controller to provide a tamper detection input when the programming switch is actuated.

As discussed above, a microprocessor changes between the armed mode and disarmed mode in response to RF signals from the remote controller board 120 that is capable of sending an arming signal, a disarming signal, and a reset signal. The specific frequency of the signals periodically changes to a different randomly selected signal. The method of selecting frequencies is synchronized between any receiver and the control board 120 to protect against unauthorized signals communicating with the microprocessor to disarm or reset the alarm unit. In addition, a “panic” feature may be included in which the alarm may be triggered by pressing a panic button. The control board 120 treats the panic input as a tamper detection input.

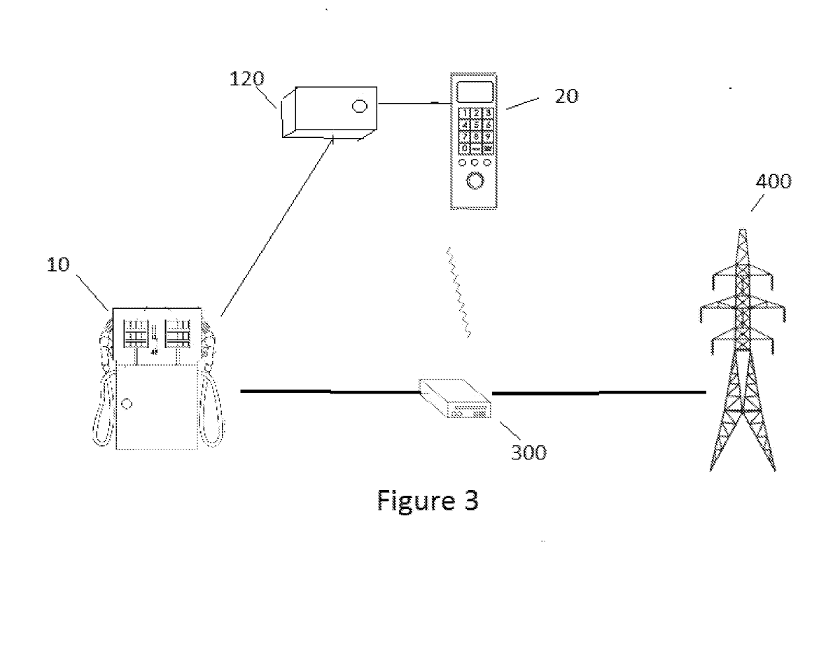

FIG. 3 shows a computer control board 120. The computer control board 120 is programmed to respond according to signal “fault”, it also communicates through Internet or wireless “Alerts”, it manages breaker 300 Relays to cut or restore “Power” and is integrated with a digital keypad 20 in the preferred embodiment.

The Control boards 120 and Relay breakers 30p are serialized to manage the power source 300 where they can disable dispensing thus stopping fuel theft which also have a manual override feature.

The wireless receiver 125 receives wireless signals and route the signals to a computer board or microprocessor 145.

The system will have a light detector 110 within the dispenser 10. This will be a photinc cell that will distinguish ambient light. This light detector will be able to let the system know if someone is opening the door or cutting into the door to tamper with dispenser 10.

In the preferred embodiment it will run off of a 3 volt battery but it can use any energy source.

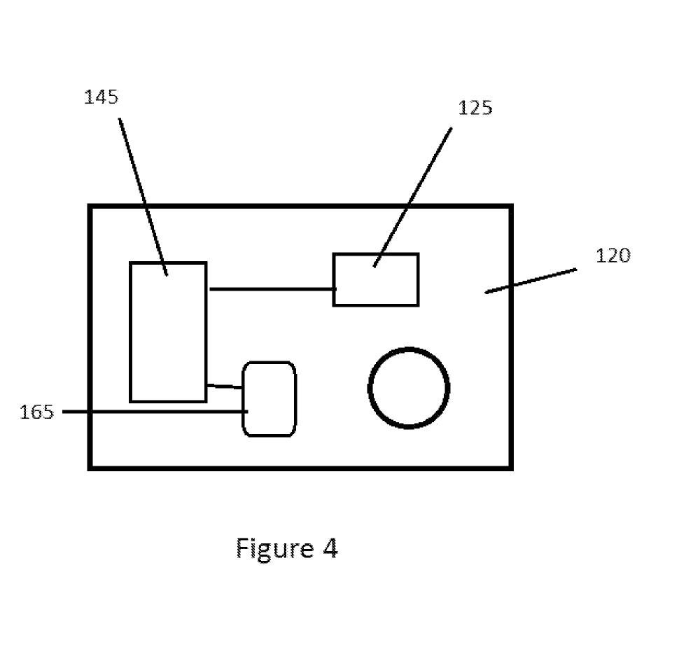

The system will have a kill at the breaker 300 instead of at the dispenser 10 for any breach as shown in FIG. 4. This will allow for real time fast disabling of the dispenser 10 and quick notification to the appropriate person.

The system will accept a signal from any device or security component to the board 120. The board 120 programming as stored in an electronic medium such as a hard drive 165 then instructs the system to take the appropriate action for outputs. Outputs can vary from sending a signal to the appropriate breaker 300 to kill power 400 (stopping fuel loss) to sending alerts to digital keypad/display 20 as well as sending alerts through network connection as SMS messages, recorded messages, email or text to computers 100 or phones 150

The system uses wireless technology to secure a fuel dispenser 10. The system communicates to the control board 120 that switches a breaker 300 to kill power 400 to prevent theft.

The control board 120 will have a list of criteria that will determine if it kills the power to the dispensers 10 and/or sends a message. If this criteria is met such as is the photosenser 110 signals the control board 120 or employee theft is detected a message will be sent and/or a message

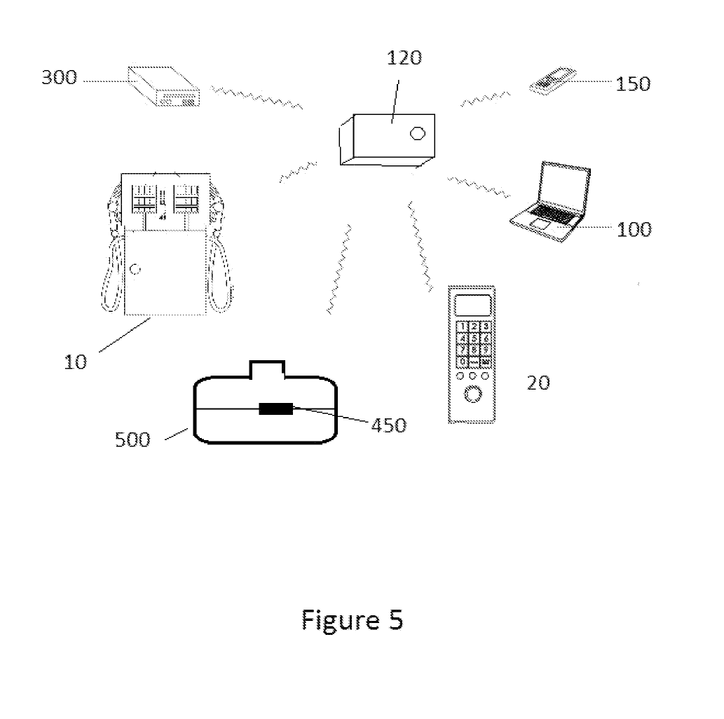

As shown in FIG. 5, the system could have a skimmer 450 in the storage tank 500 to detect the amount of fuel in the storage tank 500. If the amount in the storage tank reduces in volume in an amount that does not correspond to the amount being recorded by the dispensers 10 then the skimmer 450 will send out a message to the control board 120 and if the control board 120 is set to have this a flagged event it will send out a message and kill the power 400 to the dispensers 10. This can be used to identify employee theft or theft that bypasses the dispensers 10.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A dispenser security system for use with a dispenser that includes a dispensing mechanism that controls the dispensing of fluid from the dispenser, the dispenser security system comprising: one or more tamper detection sensors where said tamper detection sensors being adapted to detect operation of one or more dispenser components; where said sensors communication with a control board where said control board will shut off power to the dispensing mechanism through use of a breaker.

2. The dispenser security system of claim 1 wherein the one or more tamper detection sensors comprise a photosenser.

3. The dispenser security system of claim 2 wherein when the photosenser senses light it sends a signal to the control board.

4. The dispenser security system of claim 1 further comprising said control board communicates to the breaker through wireless communication.

5. The dispenser security system of claim 1 where when the control board identifies a certain criteria it will shut of the power to the dispenser.

6. The dispenser security system of claim 1 where when the control board identifies a certain criteria it will send out a message.

7. The dispenser security system of claim 6 wherein when said message is an SMS message to one or more phones.

8. The dispenser security system of claim 6 wherein when said message is a recorded message to one or more phones.

9. The dispenser security system of claim 6 wherein when said message is an E-mail message to one or more receivers.

10. The dispenser security system of claim 6 where the receiver of the message can turn off the power to one or more dispensers remotely.

11. The dispenser security system of claim 10 comprising where the power to a dispenser is turned off by a signal to the control board.

12. The dispenser security system of claim 1 comprising where the power to a dispenser can be turned on or off from an input device.

13. The dispenser security system of claim 12 wherein the input device is a keyboard.

14. The dispenser security system of claim 5 wherein the control board will also send out a message.

15. The dispenser security system of claim 1 wherein a skimmer will communicate with the control board.

16. The dispenser security system of claim 16 wherein the control board determines there is a discrepancy between the skimmer and the dispensers it will shut off power to the dispenser and said a message.

17. The dispenser security system of claim 1 wherein the dispenser includes a plurality of independently operable dispensers.

18. The dispenser security system of claim 1 wherein the dispenser security controller includes a radio frequency receiver adapted to receive a radio frequency arming signal that places the dispenser security controller in an armed mode in which the dispenser security controller generates a trigger signal in response to a tamper detection input and a radio frequency disarming signal that places the dispenser security controller in a disarmed mode in which the dispenser security controller does not generate a trigger signal in response to a tamper detection input.

19. A method that disables dispensing of fluid from a dispenser, wherein the remote control board is capable of sending an arming signal, a disarming signal, and a reset signal.

20. A dispenser security system for use with a dispenser that includes a dispensing mechanism that controls the dispensing of fluid from the dispenser, the dispenser security system comprising: one or more tamper detection sensors where said tamper detection sensors being adapted to detect operation of one or more dispenser components; where said sensors communication with a control board where said control board will shut off power to the dispensing mechanism through use of a breaker where said control board communicates to the breaker through wireless communication when the control board identifies a certain criteria it will shut of the power to the dispenser and send out a message.
